(19) United States
(12) Patent Application Publication
(10) Pub. No.: US 2007/0044442 A1
(43) Pub. Date: Mar. 1, 2007

(54) Large capacity vacuum filter cartridge

(76) Inventors: Phillip B. Riedel, Minneapolis, MN (US); Ronald J. Maksymkow, Savage, MN (US)

Correspondence Address: Phillip B. Riedel, 5321 France Ave. S., Minneapolis, MN, 55410, US

(21) Appl. No.: 11/215,290

(22) Filed: Aug. 30, 2005

(51) Int. Cl. B01D 46/00

(52) U.S. Cl. 55/498

(57) ABSTRACT

A large capacity filter cartridge assembly for a vacuum cleaner that includes a main housing having an inlet and an outlet. The filter cartridge attaches to a vacuum motor cover unit. A motor provides a vacuum on the outlet of the filter cartridge thus drawing air from the inlet to the outlet, and at least a first filter is arranged between the inlet and the outlet for filtering the air. The air must pass through one, two, three, or more additional filter layers before exiting to the air pump apparatus. The described filter cartridge functions as the base for said vacuum.

### I. BACKGROUND OF THE INVENTION

A. Field of the Invention

The invention generally relates to a replaceable, large capacity vacuum filter cartridge which is designed to function as a filter and debris container.

B. Description of Prior Art

Large canister vacuum cleaners are used within industry, medical facilities, hazardous areas and homes among others. There are many manufacturers of canister vacuum cleaning machines, each with their own replaceable filter bag or small filter cartridge. There exists a need for a large capacity, self contained filter device that is easy and safe to remove and dispose of.

This invention resolves the need for a safe, self-contained filter that reduces the steps and danger when disposing of the filter with harmful debris. Large capacity filter cartridges are available in Single Layer 0.12 to 5 micron filtration, High Efficiency Particulate Air (HEPA) filtration and Ultra-Low Penetration Air (ULPA) quality.

### II. SUMMARY OF THE INVENTION

More specifically, this invention relates to a large capacity vacuum cleaner filter cartridge having primary, secondary and tertiary filters, and, with an improved filter cartridge holding capacity which is easy and safe to replace with economic advantage.

This invention provides a replaceable large capacity vacuum filter cartridge with dimensions allowing use for many applications. Said cartridge provides very high efficiency removal of fine particulates from 5 microns to 0.12 micron air filtration. Said large capacity filter will safely contain such particles as toner, ash from incinerated fuels and oils, mold spores, soot, asbestos, lead dust, allergens and the like.

The filter cartridge described can be built of with several options of filter efficiencies from Standard (0.3 micron), HEPA (99.97% efficient at 0.3 micron) and ULPA (99.999% efficient at 0.12 micron) filtration.

### III. DRAWINGS

### A. Brief Description of the Drawings

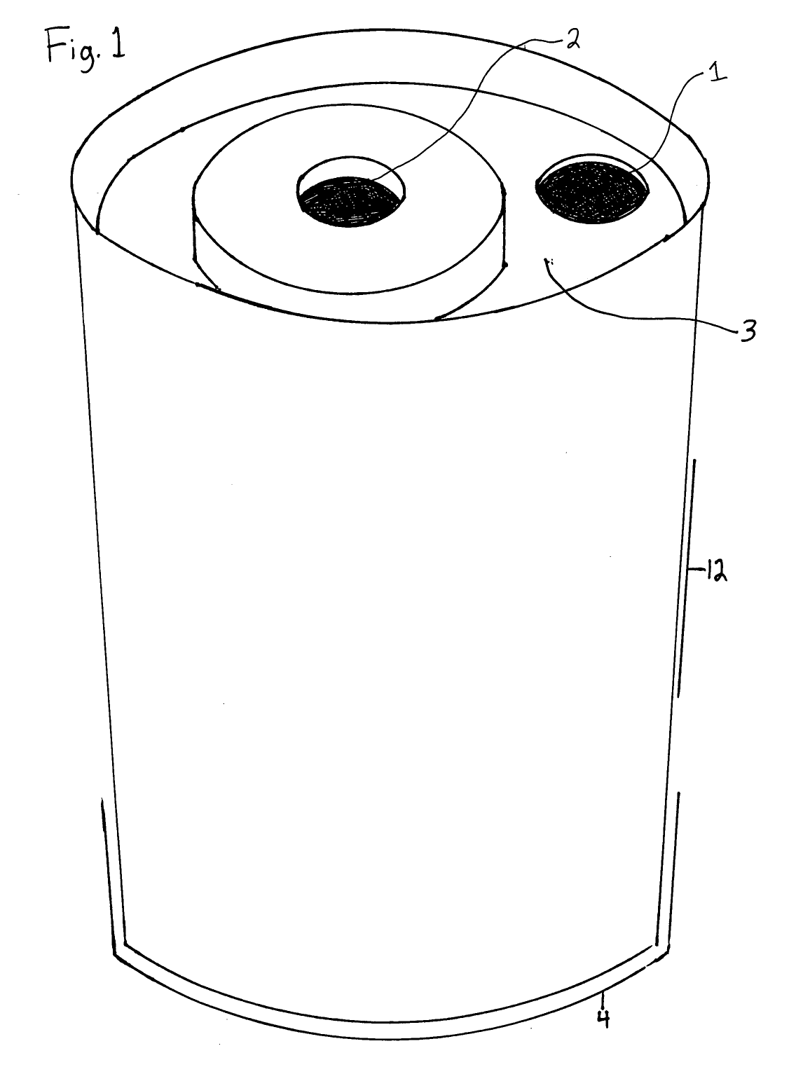

FIG. 1 illustrates the perspective view of the invention cartridge.

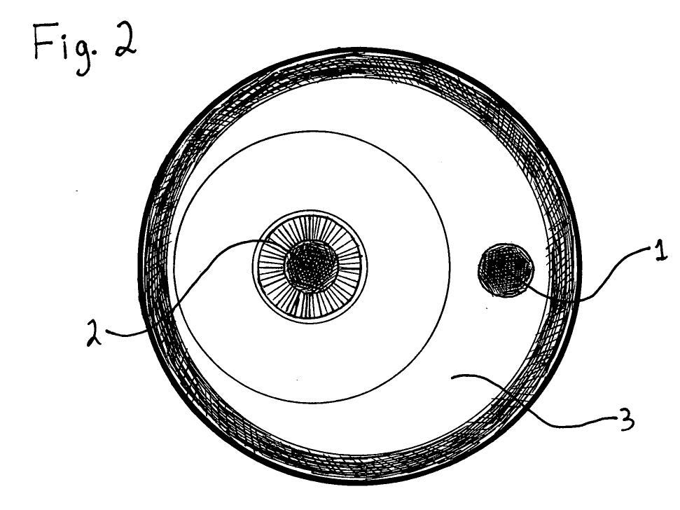

FIG. 2 illustrates the invention cartridge in top view.

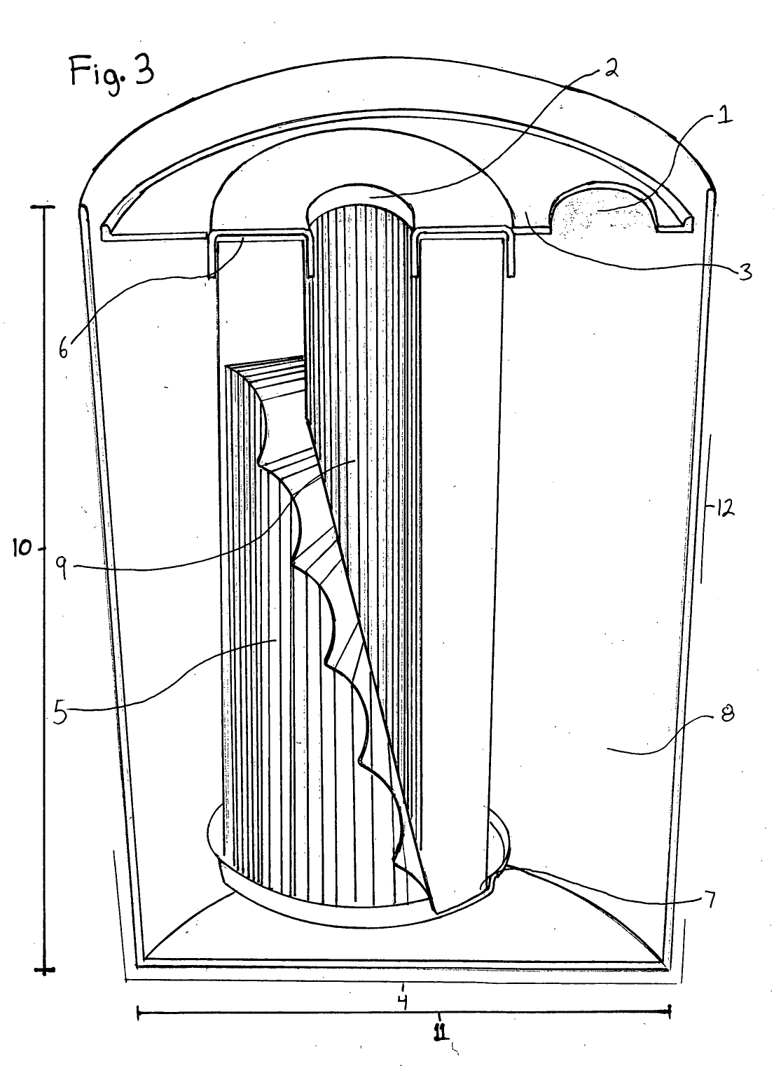

FIG. 3 illustrates the invention cartridge in longitudinal cross section.

### B. Detailed Description of the Drawings

FIG. 3 illustrates the invention cartridge in design detail. The air to be cleaned is drawn into the inlet (1) by a vacuum at the outlet (2) and collects within the outer chamber (8) of the cartridge body shell (12). The air then passes through a fan-folded filter media set (5) comprising of from one to five layers of filter material. After passing through the folded filter (5), the air collects in a central channel (9) running parallel to the length of the cartridge body (10). The cartridge body (12) is composed of two sections; The inlet and outlet section (3) and the base section (4). The top of the fan-folded filter (5) is secured and sealed to the inlet and outlet section at (6). The bottom of the fan-folded filter (5) is sealed at filter end-cap (7). The outer cartridge segments (3) and (4) are sealed together using any one of many adhesion methods including adhesives, hot-melt adhesives or ultrasonic welding.

### IV. DESCRIPTION OF THE PREFERRED EMBODIMENT

The vacuum cleaner filter cartridge referred to in FIG. 1 and shown in detail in FIG. 3 is manufactured with various dimensions. The air outlet (2) corresponds to the vacuum source of the vacuum cleaning machine.

A) Atrix International, Inc.: HCTV (High Capacity Vacuum)

Referring to FIG. 1 and FIG. 3; The Height (10) varies from less than 32 inches (812.8 mm) to greater than 14 inches (355.6 mm). The diameter (11) varies from less than 14 inches (355.6 mm) to greater than 11 inches (279.4 mm). The inlet (1) ID is 1.5 inches (38.1 mm) plus or minus 1 inch (25.4 mm). The outlet ID is 2.5 inches (63.5 mm) plus or minus 1 inch (25.4 mm).

Referring to FIG. 3, the preferred embodiment includes at least a single ply filter media in the fan-folded filter (5) and at least 25 pleats and as many as 80 pleats. The depth of each pleat is at least 0.25 inch (6.35 mm) and can be as much as 1.75 inches (44.45 mm). Said filter has at least a 0.5 micron filter media, HEPA (0.3 micron), or ULPA (0.12 micron) filtration efficiency.

What is claimed is:

1. A large capacity vacuum cleaner filter cartridge for a vacuum cleaning machine, comprising:
a cartridge body having an inlet and an outlet;
a first fan folded, single ply fan folded or a multi layered filter for filtering air disposed therein between the said inlet and outlet portions of the cartridge body;
a top cover insert and base container forming said cartridge and holding the fan-folded filter;
said cartridge having a top cover shell insert which receives the inlet aperture;
said cartridge having a bottom lower base shell which contains the outlet aperture;
said top shell insert being generally round and said lower base shell being generally cylindrical.

2. A filter cartridge as in claim 1, wherein said outside cartridge has varying height dimensions of 14.5″ (368.3 mm) to 32″ (812.80 mm).

3. A filter cartridge as in claim 1, wherein said cartridge has varying outside width dimensions of 11.5″ (292.10 mm) to 14″ (355.6 mm).

4. A filter cartridge as in claim 1, wherein an inside diameter of said inlet is less than 1.55 inches (39.37 mm) and greater than 1.45 inches (36.83 mm).

5. A filter cartridge as in claim 1, wherein an inside diameter of said outlet is less than 2.55 inches (64.77 mm) and greater than 2.45 inches (62.23 mm).

6. A filter cartridge as in claim 1, wherein; said fan folded filter media contains at least one layer of filter media.

7. A filter cartridge as in claim 8 wherein said filter is rated an HEPA filter.

8. A filter cartridge as in claim 8 wherein said filter is rated an ULPA filter.

9. A filter cartridge as in claim 8 wherein said fan folded filter includes at least 25 pleats.

10. A filter cartridge as in claim 8 wherein said fan folded filter contains pleats at least 0.25 inches (6.35 mm) in depth.

11. A vacuum cleaner filter cartridge for a vacuum cleaning machine, comprising: a cartridge body having an inlet and an outlet; at least a single layered fan folded filter for filtering air disposed therein between the said inlet and outlet portions of the cartridge body shell; a top cover shell insert and base shell forming said cartridge and holding the fan-folded filter; said cartridge having a top cover shell insert which receives the inlet aperture; said cartridge having a top cover shell insert which contains the outlet aperture; said cartridge having an outside length dimension less than 32 inches (812.8 mm) and greater than 14 inches (355.6 mm); said cartridge having an outside width dimensions less than 14 inches (355.6 mm) and greater than 11 inches (279.4 mm).
